(19) United States
(12) Patent Application Publication
(10) Pub. No.: US 2007/0289556 A1
(43) Pub. Date: Dec. 20, 2007

(54) Pet stairs

(76) Inventors: Patrick Hoffman, Arlington, TX (US); Charles E. Wagner, Winfield, KS (US)

Correspondence Address: CRUTSINGER & BOOTH, 1601 ELM STREET, SUITE 1950, DALLAS, TX, 752014744, US

(21) Appl. No.: 11/374,601

(22) Filed: Mar. 13, 2006

(51) Int. Cl. A01K 29/00; B65G 69/28

(52) U.S. Cl. 119/847

(57) ABSTRACT

A portable stair case, disclosed herein generally comprises two components, each of which is preferably of unitary construction, a blow molded body having a flight of a succession of steps formed on the front of body, and a blow molded leg, the two components being configured with connector parts with an interference fit and a cantilever snap-fit mechanism configured to prevent disengagement of the leg component from the body.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO MICROFICHE APPENDIX

Not applicable

### TECHNICAL FIELD

The invention relates to a portable stair case formed by an assembly of hollow blow molded components joined by connector parts having an interference fit and snap-fit connectors.

### BACKGROUND OF INVENTION

Several configurations of stair steps and ramps have been devised heretofore for allowing animals to reach different heights.

The dog and pet stairs and ramps have been designed to give dogs and other pets access to a couch, bed, or back seat of an automobile or truck. Attempts to make pet stairs portable, while accommodating different sizes and weights of animals, have not been successful.

U.S. Pat. No. 3,618,568 discloses a pet house having a ramp at an entrance to the house. The ramp is a hinged plank of solid material, such as wood, and includes added steps or slats to provide traction for the pet to climbs the ramp.

U.S. Pat. No. 5,213,060 discloses a pet ramp having a frame with flexible material mounted on the frame. The ramp is intended to be inclined against and supported at its top end by a bed. A first anchoring flap of material extending from the frame, is provided for securing the frame to the bed, while a second anchoring device, in the form of high friction cups on the ends of the frame engaging the floor, secures the bottom end of the frame against slippage. The flap slips between a mattress and a box spring of the bed and is securely held there, so the frame will not move.

U.S. Pat. No. 5,592,801 discloses a mobile stair system for pets and other small animals comprising a number of crossbars, a left side support and a right side support which jointly form a main frame for the mobile stair system. A cord is run through a number of holes in the left side support and in the right side support and through the number of crossbars, forming a number of stairs of the mobile stair system.

U.S. Pat. No. 6,964,246 discloses a pet step which is a modular foam core item which can be used alone or in an arrangement with other pet steps, referred to as cubes, to form a stair and offers a way for a pet that has been debilitated by age, surgery, illness, or injury to climb, from the floor on to couch and down, eliminating the impact of jumping. Each step is formed of a washable fabric cover stretched across a high-density foam core, the core being usually of regular block shape, but alternatively in the shape of a trapezoidal block, right wedge, or other. The cover may be made from various fabrics with different textures, colors, and designs, and is secured around the foam core using a band of elastic. Thus, the cover is easily removable and washable. The pet steps are intended to be used in a stair, formed by placing the steps adjacent one another with the elasticized opening of the cover on the bottom sides of the steps and mating and engaging the optional fasteners, such as hook-and-loop fasteners, which are mounted between the adjacent step surfaces.

Design Pat. No. D320,702, Design Pat. No. D429,038 and Design Pat. No. D383,261 disclose what appear to be one piece stair steps for pets.

The construction of dog and pet stairs and ramps heretofore devised has been labor intensive. The steps designed to give dogs and other pets access to a couch, bed, or back seat of an automobile or truck have been heavy and often unsightly structures, which made them undesirable for use in many homes. Attempts to make pet stairs portable, while accommodating different sizes and weights of animals, have not been successful.

### SUMMARY OF INVENTION

The dog and pet stairs disclosed herein are designed to give dogs and other pets access to a couch, bed, or back seat of an automobile. These pet stairs are portable weighing only about 10 pounds and offer attractive styling and are inexpensive to manufacture. The structure of the illustrated embodiment, constructed of hollow light weight components weighing only about 10 pounds, is configured to support over 250 pounds for just about any size dog or pet.

The pet stairs are uniquely designed to access the back seat of a car or truck which cannot be accessed with regular pet ramps easily. The pet stairs of the illustrated embodiment are about 16″ wide and 19″ high with 3 steps so they are compatible with most couches, beds or automobiles. A unique sloping tread design makes the pet stairs easier for small dogs to use.

Blow molding is a method of forming a uniform finished product that does not need to be joined together in any way. A hot, hollow thermoplastic tube, commonly referred to as a parison, which is either extruded or reheated, and is set within the cavity of a mold and held in place with clamps. Using a blow pin, air pressure is introduced through the inside of the parison, forcing it to assume the shape of the mold. The end product is cooled by conduction or the evaporation of volatile fluids in the product.

The blow molded components of the dog and pet stairs disclosed herein are preferably formed of high impact resin, such as high density polyethylene, and the steps are covered with indoor/outdoor carpet so they are durable and easy to clean. The molded stair construction offers modern styling suitable for use almost anywhere, indoors or outside. Regular use of the stairs saves wear and tear on joints of pets, and relieves pet owners from the task of lifting pets onto furniture or into vehicles. When the stairs are placed next to a couch or bed and pets can come and go when they please.

The portable stair case, disclosed herein generally comprises two components, each of which is preferably of unitary construction, a blow molded body having a flight of a succession of steps formed on the front of body, and a blow molded leg, the two components being configured with connector parts with an interference fit and a cantilever snap-fit mechanism configured to prevent disengagement of the leg component from the body.

The steps are arranged to form a flight of stairs on body having generally horizontal step treads on each of the steps. A sloping tread design makes it easier for small short legged dogs to use. Stringers connected to left ends of the treads support the steps and have curbs formed on upper edges of stringers and extending above upper surfaces of treads and outwardly from surfaces of step risers for forming inlay space to receive a runner of carpet extending from adjacent the rear edge of the uppermost step tread to adjacent the lower edge of the lowermost riser.

A groove formed in the body has shoulders extending longitudinally thereof, the shoulders being space apart a distance less than the thickness of a support rail such that the parts are joined by an interference fit. Space arms on the leg adjacent opposite ends of the rail have detent pins formed thereon, the arms forming cantilever latches arranged such that when the rail on the leg is urged between the shoulders on the groove in the body the detent pins snap into sockets on the body for firmly securing the leg to body.

### DESCRIPTION OF THE DRAWINGS

Drawings of a preferred embodiment of the invention are annexed hereto, so that the invention may be better and more fully understood, in which:

FIG. 1 is a perspective view illustrating the front and left side of portable stairs;

FIG. 2 is an exploded perspective view illustrating the rear and left side of portable stairs, the leg portion being separated from the body portion;

FIG. 3 is a fragmentary enlarged perspective view of the leg connector channel formed in the body;

FIG. 4 is an enlarged fragmentary view illustrating a snap-fit connector on the leg.

FIG. 5 is a side elevational view, parts being broken away to more clearly illustrate details of construction.

Numeral references are employed to designate like parts throughout the various figures of the drawing.

### DESCRIPTION OF A PREFERRED EMBODIMENT

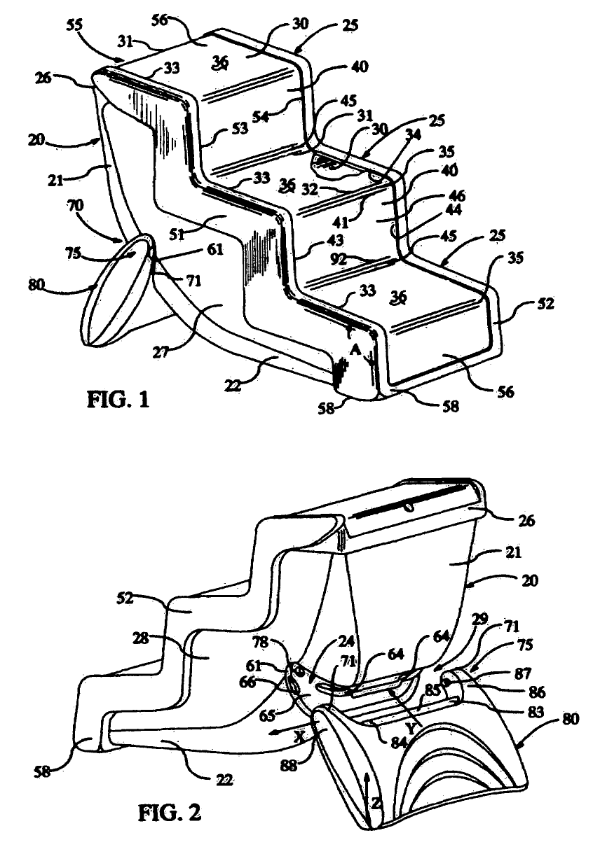

The portable stair case, generally designated by the numeral 10 in FIGS. 1 and 2 of the drawings, comprises two components, each of which is preferably of unitary construction, a blow molded body 20 and a blow molded leg 80. Body 20 and leg 80 are preferably hollow with a nominal wall thickness of about 0.100 inch and min thicknesses of about 0.040 on top radiuses and corners. The components are configured to form a snap-fit connection 70 between the body 20 and the leg 80.

A flight of a succession of steps 25 is formed on the front of body 20, which has a curved upper rear surface 21, a curved lower rear surface 22, a left and right side surfaces 27, a left side pocket 23, a right side pocket 24, and a leg connector channel 29. A header 26 is formed on the upper edge of the curved upper rear surface 21 and a foot 58 is formed on the front edge of the curved lower rear surface 22.

Steps 25 are formed by generally horizontally extending treads 30 and generally vertically extending risers 40. The width of tread 30 of a step 25 is the horizontal distance between the outer faces of two consecutive risers 40. Each tread 30 comprises an upper tread surface 36 bounded by a back edge 31, a front edge 32, a left end 33, a right end 34 and a nosing surface 35 on the front edge 32 of the tread 30. Each riser 40 comprises an inclined riser face surface 46 bounded by an upper edge 41, a lower edge 42, left end 43, right end 44 and a coving surface 45 on the lower edge 42 of riser 40.

The upper tread surfaces 36 on treads 30 and the inclined riser face surfaces 46 on risers 40 preferably lie in plains that intersect at an angle of inclination “A” that is greater than 90 degrees and preferably about 100 degrees. The sloping tread and riser configuration makes it easier for small dogs, especially dachshunds, to use the stair case 10.

A left stringer 51 is formed on body 20 between the left side surface 27 and left ends of steps 25 and a right stringer 52 is formed between right side surface 28 and right ends of steps 25. Stringers 51 and 52 have a left curb 53 and a right curb 54 formed on upper edges thereof to provide inlay space 55 to receive a runner 56 of carpet, rubber or other material. Stringers 51 and 52 are formed in a stair-step configuration which provides both vertical and horizontal support for treads 30 and risers 40. Side surfaces 27 and 28 extend downwardly from stringers 51 and 52 and provide a substantial thickness below stringers 51 and 52. It should be appreciated that when a downward load is applied to a tread 30, the horizontal portions of stringers 51 and 52, connected to edges 33 and 34 of treads 30, are in compression while ends of the horizontal portions are supported by vertical portions of the stringers at ends 43 and 44 of the risers 40. The side surfaces 27 and 28, connected to horizontal and vertical portions of stringers 51 and 52 are in tension, forming a series of triangular shaped trusses for stiffening and supporting each step 25.

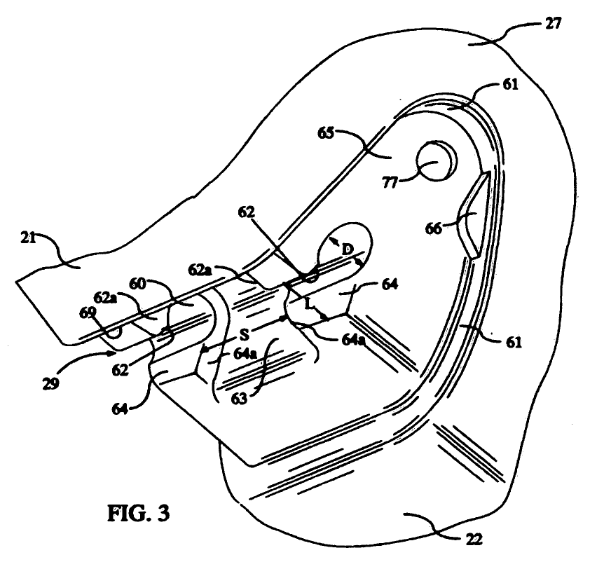

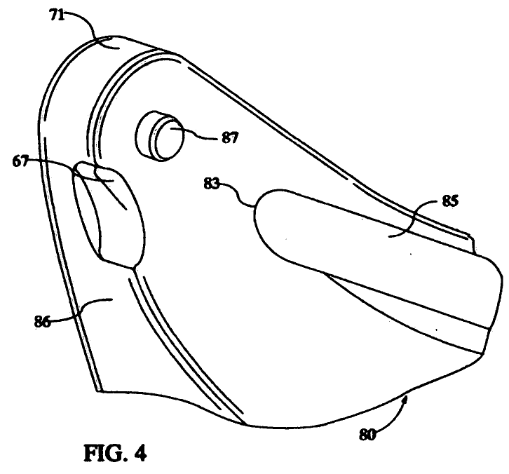

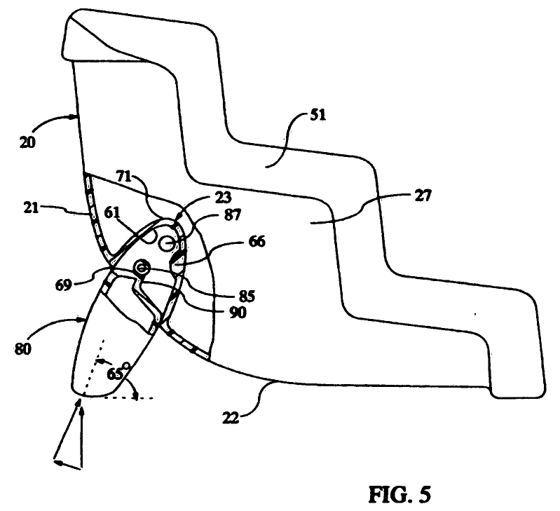

Referring to FIGS. 2 and 3 of the drawings, groove segments 60, bounded by upper shoulders 62 and lower shoulders 64, are formed in leg connector channel 29 at opposite ends of cutout 63. Grove segments 60, in a preferred embodiment, have a diameter “D” and shoulders 62 and 64 are vertically space a distance “L”. Inner edges 62a and 62b of upper and lower shoulders 62 and 64, adjacent opposite ends of cutout 63, are horizontally space apart a distance “S”.

Left side pocket 23 and a right side pocket 24 are formed at opposite ends of leg connector channel 29. Each side pocket 23 and 24, having an inset surface 65 recessed inwardly relative to rear surfaces 21 and 22 and side surfaces 27 and 28, is bounded by a curved load baring rim 61. Inset surfaces 65 in side pockets 23 and 24 diverge and have sockets 77 and 78 formed therein for receiving pins 87 and 89 on cantilever latches 75, as will be hereinafter more filly explained.

The second component of the assembly, in the illustrated embodiment, is a leg 80, illustrated in FIGS. 2,4 and 5 of the drawings. As hereinbefore explained, body 20 and leg 80 are preferably hollow with a nominal wall thickness of about 0.100 inch and minimum thicknesses of about 0.040 on top radiuses and corners. The components are configured to form a snap-fit connection 70 between the body 20 and the leg 80.

A rail 85, formed on leg 80, has a width W which is greater than the distance L between shoulders 62 and 64 on body 20. The rail 85, in the illustrated embodiment, is a straight bar that is longer than it is wide and functions as the primary support for the body 20. Rail 85 is a hollow tubular member that is formed by pressurized fluid flowing through arms 86 and 88 into opposite ends 83 and 84 of rail 85, the web portion 90 of leg 80 being an elongated solid member. During the blow molding process, the parison is set within the cavity of a mold and pinched in the region extending between hollow arms 86 and 88 and along the length of rail 85. Fluid pressure is introduced through the inside of the parison, forcing it to assume the shape of the mold.

Space arms 86 and 88 are formed on leg 80 adjacent opposite ends 83 and 84 of rail 85. Arms 86 and 88, having pins 87 and 89 formed thereon, form cantilever latches, generally designated by the numeral 75, arranged such that when rail 85 on leg 80 is urged between shoulders 62 and 64 into groove segments 60 in body 20, pins 87 and 89 snap into detent sockets 77 and 79 formed in inset surfaces 65 in side pockets 23 and 24 for securing leg 80 to body 20. Arms 86 and 88 have curved end surfaces 71 that engage rim surfaces 61 in side pockets 23 and 24 that are load baring surfaces for applying reaction forces to leg 80 along with surfaces in groove segments 60 engaged by rail 85. A major portion of the force exerted on body 20 by leg 80, to resist rotation of body 20 when weight is applied to stairs 25, is distributed by the grove segments 60 and surfaces 61 and 71 to opposite sides of the body 20 for providing a strong rigid structural assembly, even though the components 20 and 80 are light weight hollow parts. The leg connector channel 29 in the rear of body 20 with groove segments formed therein forms a first connector part 60 on the first component 10; and the rail 85, extending between arms 86 and 87 on the second leg component 80, forms a second connector part 85 on the second component 80.

To ensure proper fit of the components in the assembly, it is essential that the pins 87 and 89, that secure the leg 80 and body 20 together, fit into their mating sockets 77 and 79 properly. Too tight a fit can lead to broken pins; too loose, and the leg 80 may become disengaged from the body 20, if extreme twisting force is applied to the leg 80. The pins 87 and 89 have convex ends that are self-centering in the corresponding sockets 77 and 79 to facilitate the assembly process. Inset surfaces 65 are curved such that the surfaces 65 in side pockets 23 and 24 diverge from rear surfaces 21 and 22. It should be noted that the hollow arms 86 and 88 are narrow, measured in a horizontal plain, and thick, measured in a vertical plain. This configuration allows arms 86 and 87 to deflect outwardly as pins 87 and 89 are urged along diverging inset surfaces 65.

It should be appreciated that the assembly of hollow blow molded components hereinbefore described is formed by a first component 20, having a first connector part 60 on the first component; and a second component 80 having a second connector part 85 on the second component, the first and second connector parts 60 and 85 being configured for an interference fit requiring pressure to deflect one of the parts to force the connector parts together. A cantilever snap-fit mechanism 70 is provided on the first and second components 20 and 80 for locking the components together when the first and second connector parts 60 and 85 are urged into a seated position. The cantilever snap-fit mechanism 70, including arms 86 and 88, is configured to require movement of the arms 86 and 88 on snap-fit connection mechanism 70 in a first direction X outwardly for movement of the connector parts 60 and 85 in a second direction Y toward each other. The first and second connector parts 60 and 85 and the cantilever snap-fit mechanism 70 are configured to prevent movement of the second leg component 80 relative to the first body component 20 in a third direction Z, such that the leg 80 firmly supports body 20 in a stable position.

Although the preferred embodiment of the invention has been described in some detail for purposes of clarity of understanding, it will be apparent that certain changes and modifications may be made, for example the first and second connector parts and the snap-fit mechanism 75 may replace or may be formed as separate parts which are not integral parts of the body 20 or the leg 80, without departing from the basic concept of the invention.

Support shoulders 66 are formed on lower surfaces of rim 61 in each side pocket 23 and 24 and are positioned to engage stabilizer cam lugs 67 formed in guide channels 68. The lugs 67 form curved surfaces for stiffening and distributing loading between ends of the arms 86 and 88 and the rim 61. A reaction surface 69 extends across the upper edge of leg connector channel 29 and engages the upper surface of leg 80 that extends between upper edges of arms 86 and 88.

Terms such as “left,” “right,” “clockwise,” “counter-clockwise,” “horizontal,” “vertical,” “up,” and “down” when used in reference to the drawings, generally refer to the orientation of the parts in the illustrated embodiment and not necessarily during use. These terms used herein are meant only to refer to relative positions and/or orientations, for convenience, and are not to be understood to be in any manner otherwise limiting.

The dog and pet stairs disclosed herein are designed to give dogs and other pets access to a couch, bed, or back seat of an automobile. The pet stairs are portable weighing only about 10 pounds, offer attractive styling and are inexpensive to manufacture. The structure of the illustrated embodiment, constructed of hollow light weight components weighing only about 10 pounds, is configured to support over 250 pounds for just about any size dog or pet.

The pet stairs are uniquely designed to access the back seat of a car or truck which cannot be accessed with regular pet ramps easily. The pet stairs of the illustrated embodiment are about 16″ wide and 19″ high with 3 steps so they are compatible with most couches, beds or automobiles. The unique sloping tread design makes the pet stairs easier for small dogs to use.

The blow molded components are preferably constructed of high impact resin, such as high density polyethylene, and the steps are covered with indoor/outdoor carpet so they are durable and easy to clean. The molded stair construction offers modern styling suitable for use well almost anywhere, indoor or outside. Regular use of the stairs saves wear and tear on joints of pets, and relieves pet owner from the task of lifting pets onto furniture or into vehicles. When the stairs are placed next to a couch or bed and pets can come and go when they please.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

1. An assembly of hollow blow molded components comprising:
a first component;
a first connector part on said first component;
a second component;
a second connector part on said second component, said first and second connector parts being configured for an interference fit requiring pressure to deflect one of said parts to force the connector parts together; and
a cantilever snap-fit mechanism on said first and second components for locking said components together when said first and second connector parts are urged into a seated position, said cantilever snap-fit mechanism being configured to require movement of said mechanism in a first direction for movement of said connector parts in a second direction, said first and second connector parts and said cantilever snap-fit mechanism being configured to prevent movement of said second component relative to said first component in a third direction.

2. An assembly of hollow blow molded components, according to claim 1, said first component having a leg connector channel with groove segments formed therein to function as said first connector part on said first component.

3. An assembly of hollow blow molded components, according to claim 2, said second connector part on said second component comprising:
spaced arms on the second component; and
a rail, extending between said arms, said rail being positioned in said groove segments on said first component.

4. An assembly of hollow blow molded components, according to claim 1, said first component having groove segments formed therein, said second connector part on said second component comprising:
a rail extending into said groove segments.

5. An assembly of hollow blow molded components, according to claim 1, said cantilever snap-fit mechanism being configured to require movement of said mechanism in a first direction X for movement of said connector parts in a second direction Y, said first and second connector parts and said cantilever snap-fit mechanism being configured to prevent movement of said second component relative to said first component in a third direction Z.

6. An assembly of hollow blow molded components, according to claim 1, said first component having a groove and spaced side pockets, having diverging surfaces forming said first connector part on said first component, said second connector part on said second component comprising:
first and second arms on said second component, each of said first and second arms having a length, a width and a thickness; each of said first and second arms having inner and outer surfaces and having ends extending from said second component, said length and thickness being greater than said width such that said first and second arms can be deflected laterally for increasing the distance between said inner surfaces when said inner surfaces engage said diverging surfaces on said first component.

7. An assembly of hollow blow molded components, according to claim 6, said diverging surfaces having sockets formed therein, said cantilever snap-fit mechanism on said first and second components for locking said components together when said first and second connector parts are urged into a seated position, comprising:
detent pins, on said first and second arms, said detent pins being configured to snap into said sockets.

8. An assembly of hollow blow molded components, according to claim 1, said a first component comprising:
a body having steps formed thereon;
generally horizontal step treads on each of said steps, each of said step treads having a back edge, a front edge, a left end and a right end;
generally vertical step risers, each of said step risers having an upper edge, a lower edge, left end and right end;
rounded nosing surfaces extending longitudinally of front edges of each step tread for connecting the front edge of one tread to the upper edge of the next tread below it;
rounded coving surfaces extending longitudinally of lower edges of each step riser for connecting the back edge of one tread to the lower edge of the next riser above it;
first and second stringers, said first stringer being connected to left ends of treads and left ends of risers for supporting left ends of the steps; said second stringer being connected to right ends of treads and right ends of risers for supporting right ends of the steps; and
curbs formed on upper edges of said stringers and extending above upper surfaces of said treads and outwardly from surfaces of said step risers for forming inlay space to receive a runner of carpet extending from adjacent rear edge of the uppermost step tread to adjacent the lower edge of the lowermost riser.

9. An assembly of hollow blow molded components, according to claim 1, said a second component comprising:
a leg,
a rail on said leg, said rail having a width W which is greater than the distance L between shoulders on the body; and
space arms on said leg adjacent opposite ends of said rail, said arms having lugs formed thereon, said arms forming cantilever latches.

10. Steps arranged to form a flight of stairs comprising:
a body having steps formed thereon;
generally horizontal step treads on each of said steps, each of said step treads having a back edge, a front edge, a left end and a right end;
generally vertical step risers, each of said step risers having an upper edge, a lower edge, left end and right end;
nosing surfaces extending longitudinally of upper edges of each step riser for connecting the front edge of one tread to the upper edge of the next step riser below it;
coving surfaces extending longitudinally of lower edges of each step riser for connecting the back edge of one tread to the lower edge of the next step riser above it;
first and second stringers, said first stringer being connected to left ends of treads and left ends of risers for supporting left ends of the steps; said second stringer being connected to right ends of treads and right ends of risers for supporting t right ends of the steps;
curbs formed on upper edges of said stringers and extending above upper surfaces of said treads and outwardly from surfaces of said step risers for forming inlay space to receive a runner of carpet extending from adjacent rear edge of the uppermost step tread to adjacent the lower edge of the lowermost riser, said body having a groove formed in said body, said groove having shoulders extending longitudinally thereof, said shoulders being space apart a distance L, said body having first and second sockets formed therein and a lug adjacent each of said sockets;
a leg,
a rail on said leg, said rail having a width W which is greater than the distance L between said shoulders on said body;
space arms on said leg adjacent opposite ends of said rail; and
arms having pins formed thereon, said arms forming cantilever latches arranged such that when said rail on said leg is urged between said shoulders on said groove in said body, said pins snap into detent sockets for preventing disengagement of said rail from said groove.

11. Steps arranged to form a flight of stairs comprising:
a body having steps formed thereon;
generally horizontal step treads on each of said steps, each of said step treads having a back edge, a front edge, a left end and a right end;
generally vertical step risers, each of said step risers having an upper edge, a lower edge, left end and right end;
stringers, one of said stringers being connected to left ends of threads and left ends of risers for supporting left ends of the steps; another of said stringers being connected to right ends of treads and right ends of risers for supporting right ends of the steps, said body having a groove formed therein;
a leg; and
connector means joining said leg and said body for preventing disengagement of said leg from said groove and for preventing rotation of said leg relative to said body when weight is applied to said steps.
